(19) United States
(12) Patent Application Publication
(10) Pub. No.: US 2011/0243093 A1
(43) Pub. Date: Oct. 6, 2011

(54) Method and Apparatus for Pre-Uplink Synchronization in TD-SCDMA Handover

(76) Inventors: Tom Chin, San Diego, CA (US); Guangming Shi, San Diego, CA (US); Kuo-Chun Lee, San Diego, CA (US)

(21) Appl. No.: 12/846,639

(22) Filed: Jul. 29, 2010

Related U.S. Application Data
(60) Provisional application No. 61/320,956, filed on Apr. 5, 2010.

(51) Int. Cl. H04W 4/00

(52) U.S. Cl. 370/331

(57) ABSTRACT

Certain aspects of the present disclosure propose techniques and apparatus for pre-uplink synchronization in Time Division Synchronous Code Division Multiple Access (TD-SCDMA) handover.

### CLAIM OF PRIORITY UNDER 35 U.S.C. §119

This application claims the benefit of U.S. Provisional Patent Application No. 61/320,956 entitled: “Method and Apparatus for Pre-Uplink Synchronization in TD-SCDMA Handover,” filed on Apr. 5, 2010, the disclosure of which is expressly incorporated by reference herein in its entirety.

### BACKGROUND

1. Field

Aspects of the present disclosure relate generally to wireless communications, and more particularly, to a method and apparatus for pre-uplink synchronization in Time Division Synchronous Code Division Multiple Access (TD-SCDMA) handover.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile communications (GSM) technologies, currently supports various air interface standards, such as Wideband-Code Division Multiple Access (W-CDMA), Time Division—Code Division Multiple Access (TD-CDMA), and Time Division—Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but also to advance and enhance the user experience with mobile communications.

### SUMMARY

Certain aspects of the present disclosure provide a method of wireless communication. The method generally includes receiving a message instructing a handover of a user equipment (UE) from a source cell to a target cell, the message including at least one of timing information or power adjustment information for use by the UE in communicating with the target cell.

Certain aspects of the present disclosure provide an apparatus for wireless communication. The apparatus generally includes means for receiving a message instructing a handover of the apparatus from a source cell to a target cell, the message including at least one of timing information or power adjustment information for use by the apparatus in communicating with the target cell.

Certain aspects of the present disclosure provide a computer program product. The computer program product generally includes a computer-readable medium comprising code for receiving a message instructing a handover of a user equipment (UE) from a source cell to a target cell, the message including at least one of timing information or power adjustment information for use by the UE in communicating with the target cell.

Certain aspects of the present disclosure provide an apparatus for wireless communication. The apparatus generally includes at least one processor, and a memory coupled to the at least one processor, wherein the at least one processor is configured to receive a message instructing a handover of the apparatus from a source cell to a target cell, the message including at least one of timing information or power adjustment information for use by the apparatus in communicating with the target cell.

Certain aspects of the present disclosure provide a method of wireless communication. The method generally includes transmitting a message instructing a handover of a user equipment (UE) from a source cell to a target cell, the message including at least one of timing information or power adjustment information for use by the UE in communicating with the target cell.

Certain aspects of the present disclosure provide an apparatus for wireless communication. The apparatus generally includes means for transmitting a message instructing a handover of a user equipment (UE) from the apparatus to another apparatus, the message including at least one of timing information or power adjustment information for use by the UE in communicating with the other apparatus.

Certain aspects of the present disclosure provide a computer program product. The computer program product generally includes a computer-readable medium comprising code for transmitting a message instructing a handover of a user equipment (UE) from a source cell to a target cell, the message including at least one of timing information or power adjustment information for use by the UE in communicating with the target cell.

Certain aspects of the present disclosure provide an apparatus for wireless communication. The apparatus generally includes at least one processor; and a memory coupled to the at least one processor, wherein the at least one processor is configured to transmit a message instructing a handover of a user equipment (UE) from the apparatus to another apparatus, the message including at least one of timing information or power adjustment information for use by the UE in communicating with the other apparatus.

Certain aspects of the present disclosure provide a method of wireless communication. The method generally includes receiving, at a target cell, a request message to monitor transmissions from a user equipment (UE) to a source cell, and transmitting a response message including at least one of timing information or power adjustment information based on the monitored transmissions from the UE to the source cell.

Certain aspects of the present disclosure provide an apparatus for wireless communication. The apparatus generally includes means for receiving a request message to monitor transmissions from a user equipment (UE) to another apparatus, and means for transmitting a response message including at least one of timing information or power adjustment information based on the monitored transmissions from the UE to the other apparatus.

Certain aspects of the present disclosure provide a computer program product. The computer program product generally includes a computer-readable medium comprising code for receiving, at a target cell, a request message to monitor transmissions from a user equipment (UE) to a source cell, and transmitting a response message including at least one of timing information or power adjustment information based on the monitored transmissions from the UE to the source cell.

Certain aspects of the present disclosure provide an apparatus for wireless communication. The apparatus generally includes at least one processor, and a memory coupled to the at least one processor, wherein the at least one processor is configured to receive a request message to monitor transmissions from a user equipment (UE) to another apparatus; and transmit a response message including at least one of timing information or power adjustment information based on the monitored transmissions from the UE to the other apparatus.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4 illustrates an example message sequence for a Time Division-Synchronous Code Division Multiple Access (TD-SCDMA) handover in accordance with certain aspects of the present disclosure.

FIG. 5 illustrates an example of a UE in a neighborhood of a source cell/NB and a target cell/NB in accordance with certain aspects of the present disclosure.

FIG. 6 illustrates an example message sequence for a TD-SCDMA handover with pre-uplink synchronization in accordance with certain aspects of the present disclosure.

FIG. 7 is a functional block diagram conceptually illustrating example blocks executed at the UE to implement the functional characteristics of one aspect of the present disclosure.

FIG. 8 is a functional block diagram conceptually illustrating example blocks executed at the source cell/NB to implement the functional characteristics of one aspect of the present disclosure.

FIG. 9 is a functional block diagram conceptually illustrating example blocks executed at the target cell/NB to implement the functional characteristics of one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

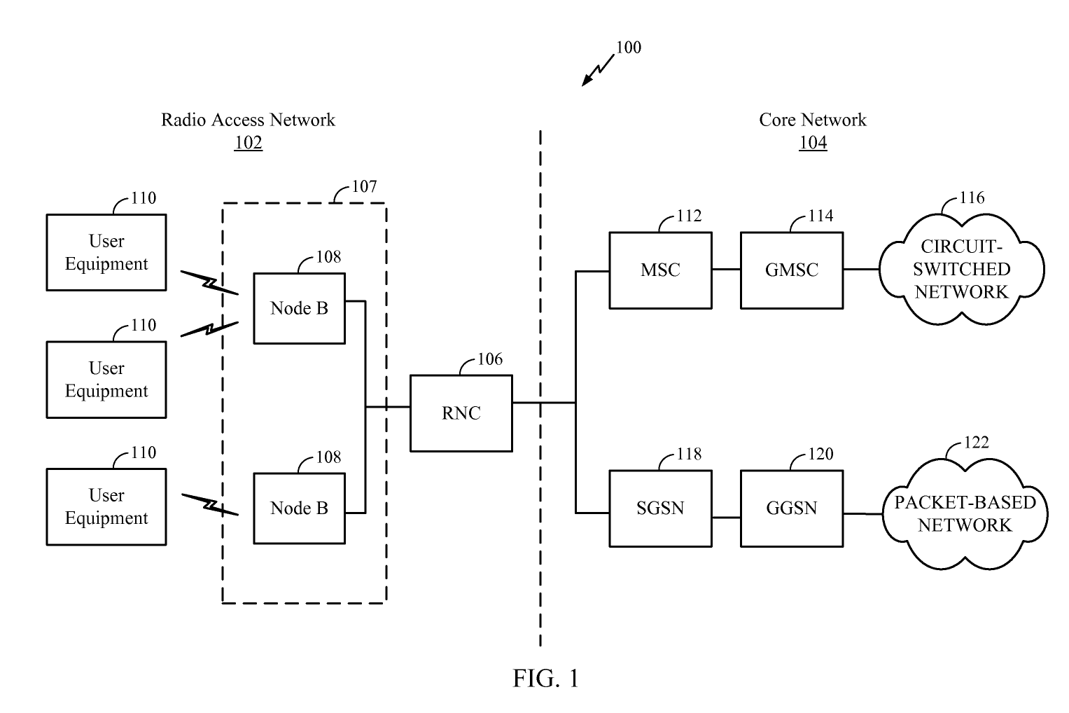

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108 are shown; however, the RNS 107 may include any number of wireless Node Bs. The Node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the Node Bs 108. The downlink (DL), also called the forward link, refers to the communication link from a Node B to a UE, and the uplink (UL), also called the reverse link, refers to the communication link from a UE to a Node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

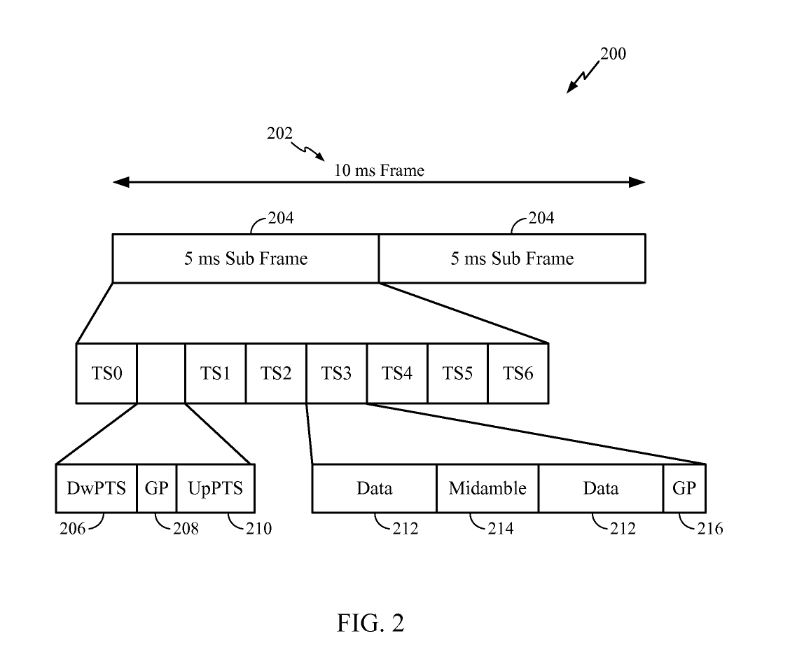

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

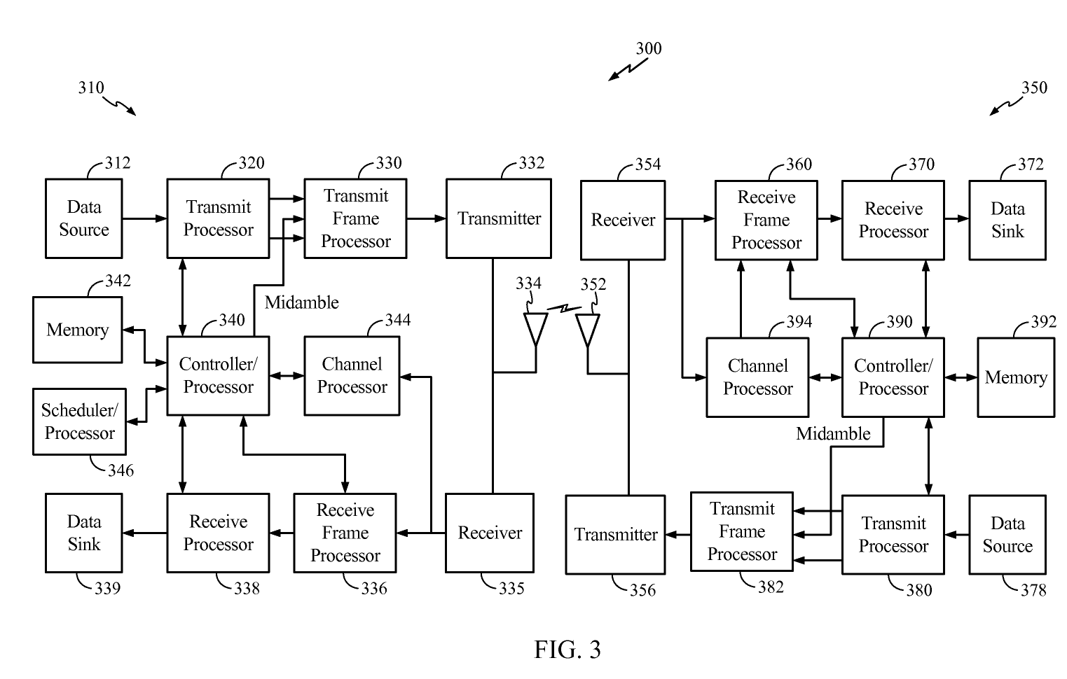

FIG. 3 is a block diagram of a Node B 310 in communication with a UE 350 in a RAN 300, where the RAN 300 may be the RAN 102 in FIG. 1, the Node B 310 may be the Node B 108 in FIG. 1 and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

### Handover in TD-SCDMA Systems

The TD-SCDMA systems support two types of handover: a hard handover and a baton handover. In the case of hard handover, a user equipment (UE) may switch at once both downlink (DL) and uplink (UL) channels from a source cell to a target cell. In the case of baton handover, the UE may first switch UL channels to the target cell, and then it may switch DL channels to the target cell. These two steps in the baton handover may allow the target cell to acquire UL, measure timing/power, and configure beam-forming before the UE switches DL channels. Therefore, the baton handover may be less disruptive than the hard handover.

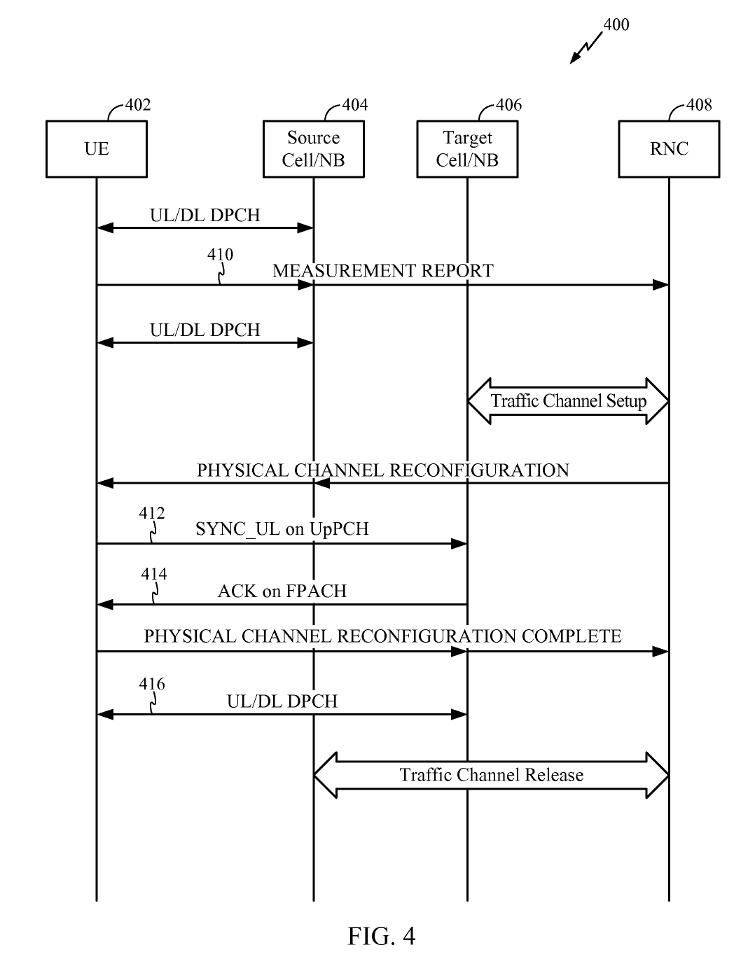

However, both types of handover may require uplink synchronization during the handover process. FIG. 4 illustrates an example message sequence 400 for a TD-SCDMA handover of a UE 402 from a source cell/NB 404 to a target cell/NB 406 in accordance with certain aspects of the present disclosure. A Radio Network Controller (RNC) 408 may receive measurement report information 410 from the UE 402, and then the RNC 408 may decide to handover the UE 402 from the source cell/NB 404 to the target cell/NB 406.

In the case of hard handover, after the UE 402 switches to the target cell/NB 406, the UE 402 may start by sending a UL synchronization code (SYNC UL) 412 on an UpPCH. Then, the UE 402 may receive an acknowledgement (ACK) 414 on the FPACH (Fast Physical Access Channel) with timing adjustment information for the UE 402 to subsequently transmit UL DPCH (Dedicated Physical Channel) data 416. On the other hand, in the case of baton handover, the UE 402 may switch UL channels first in order for the target cell/NB 406 to measure the UL timing for the subsequent adjustment in the end stage of baton handover.

Both the aforementioned UL synchronization procedures for the hard and baton handovers may delay the handover latency. For example, in the case of hard handover, the UE may be required to send the SYNC UL code, and then it may need to receive a response before the normal data transmission can start. In the case of baton handover, the UL may require fine-tuning in timing after the end of the handover.

The present disclosure provides a solution to allow a fast responsive and more efficient UL synchronization for a handover in TD-SCDMA wireless systems.

### Method and Apparatus for Pre-Uplink Synchronization In TD-SCDMA Handover

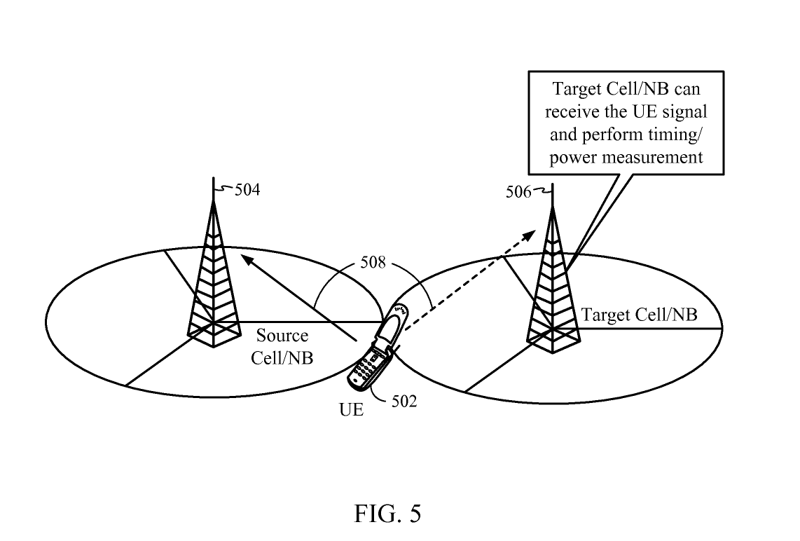

FIG. 5 illustrates an example of a UE 502 in the neighborhood of a source cell/NB 504 and a target cell/NB 506 in accordance with certain aspects of the present disclosure. Certain aspects of the present disclosure support the target cell/NB 506 to start measuring UL transmission timing in a handover preparation phase, and then to communicate the determined timing or even the power correction value within a handover signal message transmitted from the source cell/NB 504.

The key enabling function is that the neighbor cell/NB 506 may also be able to receive a UL signal 508 transmitted from the UE 502 to the source cell/NB 504 before the hard handover or the baton handover to the target cell/NB 506. Therefore, the target cell/NB 506 may also be able to measure the UL timing and power correction.

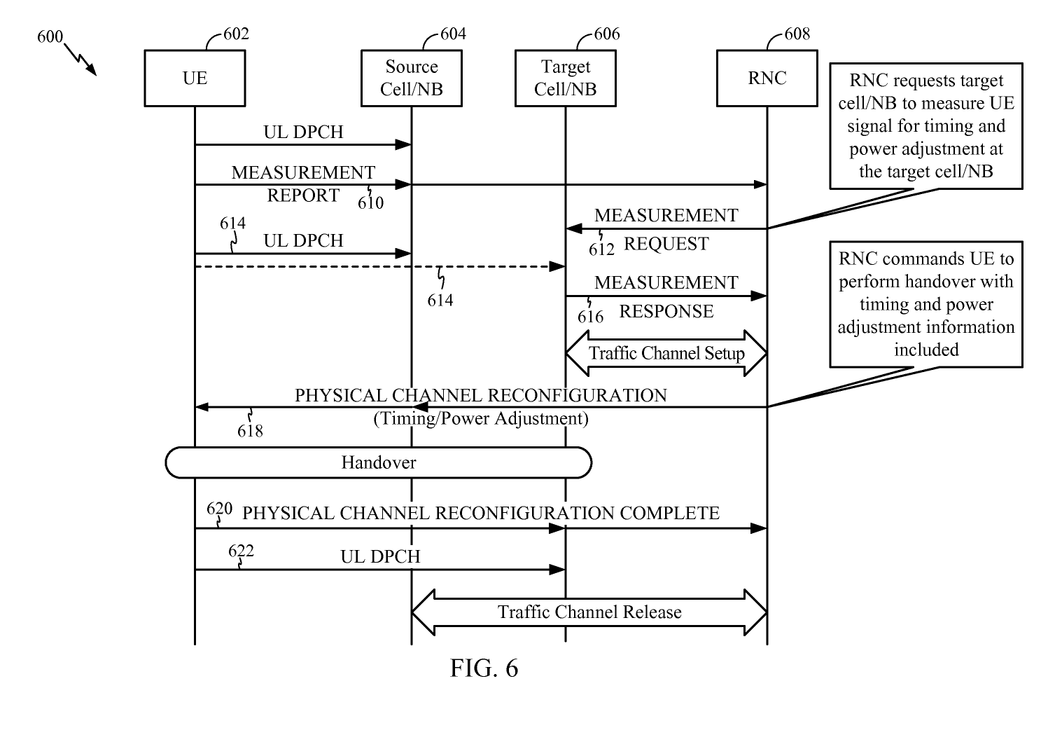

FIG. 6 illustrates an example message sequence 600 for a TD-SCDMA handover with pre-uplink synchronization in accordance with certain aspects of the present disclosure. As illustrated in FIG. 6, a handover of UE 602 from a source cell/NB 604 to a target cell/NB 606 may be performed.

A Radio Network Controller (RNC) 608 may receive measurement report information 610 from the UE 602, and then the RNC 608 may decide to handover the UE 602 to a particular target cell (e.g., to the cell/NB 606, as illustrated in FIG. 6). The RNC 608 may know configuration information related to an UL physical channel of the UE 602, such as a cell-specific scrambling code, a time slot for UL transmissions, a channelization code, and so on. The RNC 608 may forward this information to the target cell/NB 606 within a message 612 representing a request to measure timing and power level corrections related to the UE 602.

After that, in response to the measurement request 612, the target cell/NB 606 may start measuring a UL DPCH (Dedicated Physical Channel) signal 614 of the UE 602, and may generate a timing/power correction command. The target cell/NB 606 may reply to the RNC 608 with a measurement response 616 comprising the timing/power corrections.

In response to the reception of the measurement response 616, the RNC 608 may start commanding the UE 602 to perform the hard handover or the baton handover scheme as usual except the following. A handover command message 618 (i.e., the PHYSICAL CHANNEL RECONFIGURATION message, as illustrated in FIG. 6) may comprise the timing and transmit power correction relative to current timing and transmit power values used by the UE 602 for communicating with the source cell/NB 604. In the case of hard handover, the PHYSICAL CHANNEL RECONFIGURATION hard handover command message 618 may not need to comprise the SYNC UL code and FPACH information as in the case of regular hard handover.

The UE 602 may start the handover by switching UL channels (and DL channels in the case of hard handover) with the timing and power adjustment information received in the PHYSICAL CHANNEL RECONFIGURATION message 618. In the case of hard handover, the UE 602 may not need to perform UL synchronization procedure. Instead, the UE may immediately start a UL DPCH transmission 622 following a PHYSICAL CHANNEL RECONFIGURATION COMPLETE message 620 transmitted to both the target cell/NB 606 and to the RNC 608, as illustrated in FIG. 6.

In order to implement the aforementioned handover procedure 600, some interface changes may be required. For example, the Iub interface may need to be modified so that the RNC 608 may be able to request the target cell/NB 606 to measure signals of the UE 602 for timing and transmit power adjustment. Further, the Radio Resource Control (RRC) interface may need to be modified so that the PHYSICAL CHANNEL RECONFIGURATION message 616 may comprise the timing and transmit power adjustment required by the target cell/NB 606.

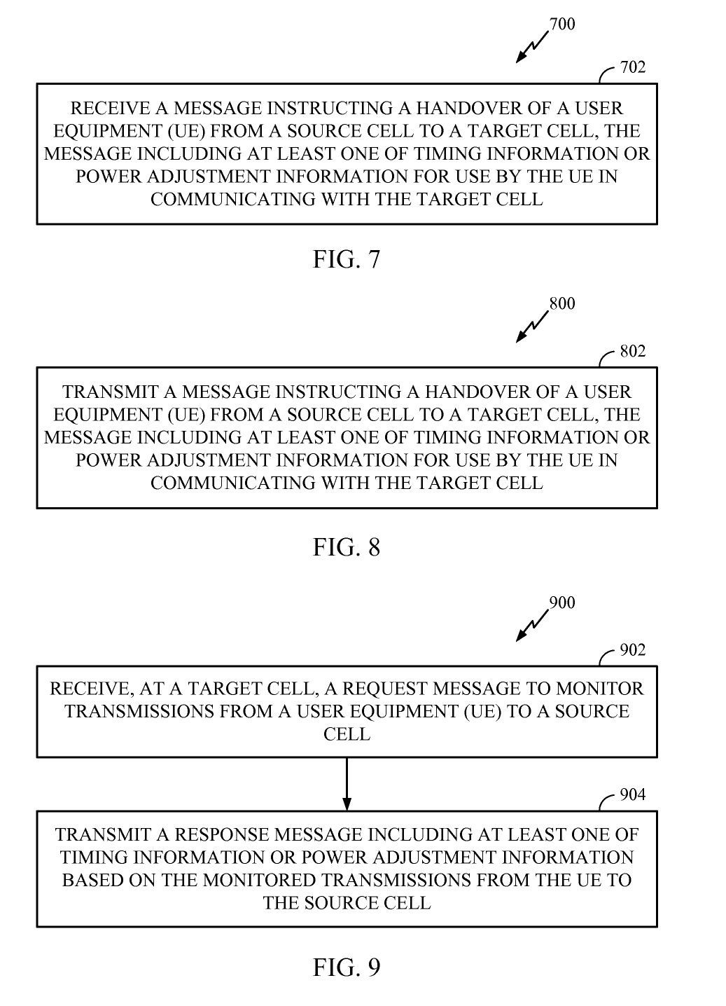

FIG. 7 is a functional block diagram conceptually illustrating example blocks 700 executed at a UE to implement the functional characteristics of one aspect of the present disclosure. Operations illustrated by the blocks 700 may be executed, for example, by the processors 370 and 380 of the UE 350 from FIG. 3. In block 702, the UE may receive a message instructing a handover of the UE from a source cell to a target cell, wherein the message may include at least one of timing information or power adjustment information for use by the UE in communicating with the target cell.

FIG. 8 is a functional block diagram conceptually illustrating example blocks executed at a source cell to implement the functional characteristics of one aspect of the present disclosure. Operations illustrated by the blocks 800 may be executed, for example, by the processors 320 and 338 of the Node B 310 from FIG. 3. In block 802, the source cell may transmit a message instructing a handover of a UE from the source cell to a target cell, the message including at least one of timing information or power adjustment information for use by the UE in communicating with the target cell.

FIG. 9 is a functional block diagram conceptually illustrating example blocks executed at a target cell to implement the functional characteristics of one aspect of the present disclosure. Operations illustrated by the blocks 900 may be executed, for example, by the processors 320 and 338 of the Node B 310 from FIG. 3. In block 902, the target cell may receive a request message to monitor transmissions from a UE to a source cell. In addition, in block 904, the target cell may transmit a response message including at least one of timing information or power adjustment information based on the monitored transmissions from the UE to the source cell.

In one configuration, the apparatus 350 for wireless communication includes means for receiving a message instructing a handover of the apparatus 350 from a source cell to a target cell, the message including at least one of timing information or power adjustment information for use by the apparatus 350 in communicating with the target cell. In one aspect, the aforementioned means may be the processors 370 and 380 configured to perform the functions recited by the aforementioned means. In another aspect, the aforementioned means may be a module or any apparatus configured to perform the functions recited by the aforementioned means.

In one configuration, the apparatus 310 for wireless communication includes means for transmitting a message instructing a handover of a UE from the apparatus 350 to another apparatus, the message including at least one of timing information or power adjustment information for use by the UE in communicating with the other apparatus. In one aspect, the aforementioned means may be the processors 320 and 338 configured to perform the functions recited by the aforementioned means. In another aspect, the aforementioned means may be a module or any apparatus configured to perform the functions recited by the aforementioned means.

In one configuration, the apparatus 310 for wireless communication includes means for receiving a request message to monitor transmissions from a UE to another apparatus, and means for transmitting a response message including at least one of timing information or power adjustment information based on the monitored transmissions from the UE to the other apparatus. In one aspect, the aforementioned means may be the processors 320 and 338 configured to perform the functions recited by the aforementioned means. In another aspect, the aforementioned means may be a module or any apparatus configured to perform the functions recited by the aforementioned means.

Certain aspects of the present disclosure provide fast handover by performing the pre-UL-synchronization procedure at a target cell/NB. The proposed method may reduce the latency and improve hand handover performance in TD-SCDMA wireless systems.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a message instructing a handover of a user equipment (UE) from a source cell to a target cell, the message including at least one of timing information or power adjustment information for use by the UE in communicating with the target cell.

2. The method of claim 1, wherein the at least one of timing information or power adjustment information is determined based on transmissions from the UE, as received by the target cell.

3. The method of claim 1, further comprising:
using the at least one of timing information or power adjustment information to communicate with the target cell during a baton handover.

4. The method of claim 1, wherein the timing information is used to adjust timing of transmissions to the target cell, relative to previous transmissions to the source cell.

5. The method of claim 1, wherein the power adjustment information is used to adjust a power for transmissions to the target cell, relative to a power for previous transmissions to the source cell.

6. The method of claim 1, further comprising:
in response to the received message during a hard handover, starting transmissions to the target cell without performing an uplink synchronization with the target cell.

7. An apparatus for wireless communication, comprising:
means for receiving a message instructing a handover of the apparatus from a source cell to a target cell, the message including at least one of timing information or power adjustment information for use by the apparatus in communicating with the target cell.

8. The apparatus of claim 7, wherein the at least one of timing information or power adjustment information is determined based on transmissions from the apparatus, as received by the target cell.

9. The apparatus of claim 7, further comprising:
means for using the at least one of timing information or power adjustment information to communicate with the target cell during a baton handover.

10. The apparatus of claim 7, wherein the timing information is used to adjust timing of transmissions to the target cell, relative to previous transmissions to the source cell.

11. The apparatus of claim 7, wherein the power adjustment information is used to adjust a power for transmissions to the target cell, relative to a power for previous transmissions to the source cell.

12. The apparatus of claim 7, further comprising:
means for starting transmissions to the target cell, in response to the received message during a hard handover, without performing an uplink synchronization with the target cell.

13. A computer program product, comprising a computer-readable medium comprising code for:
receiving a message instructing a handover of a user equipment (UE) from a source cell to a target cell, the message including at least one of timing information or power adjustment information for use by the UE in communicating with the target cell.

14. The computer program product of claim 13, wherein the at least one of timing information or power adjustment information is determined based on transmissions from the UE, as received by the target cell.

15. The computer program product of claim 13, wherein the computer-readable medium further comprising code for:
using the at least one of timing information or power adjustment information to communicate with the target cell during a baton handover.

16. The computer program product of claim 13, wherein the timing information is used to adjust timing of transmissions to the target cell, relative to previous transmissions to the source cell.

17. The computer program product of claim 13, wherein the power adjustment information is used to adjust a power for transmissions to the target cell, relative to a power for previous transmissions to the source cell.

18. The computer program product of claim 13, wherein the computer-readable medium further comprising code for:
starting transmissions to the target cell, in response to the received message during a hard handover, without performing an uplink synchronization with the target cell.

19. An apparatus for wireless communication, comprising:
at least one processor; and
a memory coupled to the at least one processor,
wherein the at least one processor is configured to
receive a message instructing a handover of the apparatus from a source cell to a target cell, the message including at least one of timing information or power adjustment information for use by the apparatus in communicating with the target cell.

20. The apparatus of claim 19, wherein the at least one of timing information or power adjustment information is determined based on transmissions from the apparatus, as received by the target cell.

21. The apparatus of claim 19, wherein the at least one processor is also configured to:
use the at least one of timing information or power adjustment information to communicate with the target cell during a baton handover.

22. The apparatus of claim 19, wherein the timing information is used to adjust timing of transmissions to the target cell, relative to previous transmissions to the source cell.

23. The apparatus of claim 19, wherein the power adjustment information is used to adjust a power for transmissions to the target cell, relative to a power for previous transmissions to the source cell.

24. The apparatus of claim 19, wherein the at least one processor is also configured to:
in response to the received message during a hard handover, start transmissions to the target cell without performing an uplink synchronization with the target cell.

25. A method of wireless communication, comprising:
transmitting a message instructing a handover of a user equipment (UE) from a source cell to a target cell, the message including at least one of timing information or power adjustment information for use by the UE in communicating with the target cell.

26. The method of claim 25, wherein the at least one of timing information or power adjustment information is determined based on transmissions from the UE, as received by the target cell.

27. The method of claim 25, further comprising:
receiving the message instructing the handover from a radio network controller.

28. An apparatus for wireless communication, comprising:
means for transmitting a message instructing a handover of a user equipment (UE) from the apparatus to another apparatus, the message including at least one of timing information or power adjustment information for use by the UE in communicating with the other apparatus.

29. The apparatus of claim 28, wherein the at least one of timing information or power adjustment information is determined based on transmissions from the UE, as received by the other apparatus.

30. The apparatus of claim 28, further comprising:
means for receiving the message instructing the handover from a radio network controller.

31. A computer program product, comprising a computer-readable medium comprising code for:
transmitting a message instructing a handover of a user equipment (UE) from a source cell to a target cell, the message including at least one of timing information or power adjustment information for use by the UE in communicating with the target cell.

32. The computer program product of claim 31, wherein the at least one of timing information or power adjustment information is determined based on transmissions from the UE, as received by the target cell.

33. The computer program product of claim 31, wherein the computer-readable medium further comprising code for:
receiving the message instructing the handover from a radio network controller.

34. An apparatus for wireless communication, comprising:
at least one processor; and
a memory coupled to the at least one processor,
wherein the at least one processor is configured to
transmit a message instructing a handover of a user equipment (UE) from the apparatus to another apparatus, the message including at least one of timing information or power adjustment information for use by the UE in communicating with the other apparatus.

35. The apparatus of claim 34, wherein the at least one of timing information or power adjustment information is determined based on transmissions from the UE, as received by the target cell.

36. The apparatus of claim 34, wherein the at least one processor is also configured to:
receive the message instructing the handover from a radio network controller.

37. A method of wireless communication, comprising:
receiving, at a target cell, a request message to monitor transmissions from a user equipment (UE) to a source cell; and
transmitting a response message including at least one of timing information or power adjustment information based on the monitored transmissions from the UE to the source cell.

38. The method of claim 37, wherein the request message comprises configuration information related to an uplink physical channel of the UE.

39. The method of claim 38, wherein the configuration information comprises at least one of: a cell-specific scrambling code, a time slot for transmitting from the UE, or a channelization code.

40. The method of claim 37, wherein the request message is received before a handover of the UE from the source cell to the target cell.

41. The method of claim 37, wherein the response message is transmitted before a handover of the UE from the source cell to the target cell.

42. An apparatus for wireless communication, comprising:
means for receiving a request message to monitor transmissions from a user equipment (UE) to another apparatus; and
means for transmitting a response message including at least one of timing information or power adjustment information based on the monitored transmissions from the UE to the other apparatus.

43. The apparatus of claim 42, wherein the request message comprises configuration information related to an uplink physical channel of the UE.

44. The apparatus of claim 43, wherein the configuration information comprises at least one of: a cell-specific scrambling code, a time slot for transmitting from the UE, or a channelization code.

45. The apparatus of claim 42, wherein the request message is received before a handover of the UE from the other apparatus to the apparatus.

46. The apparatus of claim 42, wherein the response message is transmitted before a handover of the UE from the other apparatus to the apparatus.

47. A computer program product, comprising a computer-readable medium comprising code for:
receiving, at a target cell, a request message to monitor transmissions from a user equipment (UE) to a source cell; and
transmitting a response message including at least one of timing information or power adjustment information based on the monitored transmissions from the UE to the source cell.

48. The computer program product of claim 47, wherein the request message comprises configuration information related to an uplink physical channel of the UE.

49. The computer program product of claim 48, wherein the configuration information comprises at least one of: a cell-specific scrambling code, a time slot for transmitting from the UE, or a channelization code.

50. The computer program product of claim 47, wherein the request message is received before a handover of the UE from the source cell to the target cell.

51. The computer program product of claim 47, wherein the response message is transmitted before a handover of the UE from the source cell to the target cell.

52. An apparatus for wireless communication, comprising:
at least one processor; and
a memory coupled to the at least one processor,
wherein the at least one processor is configured to
receive a request message to monitor transmissions from a user equipment (UE) to another apparatus; and
transmit a response message including at least one of timing information or power adjustment information based on the monitored transmissions from the UE to the other apparatus.

53. The apparatus of claim 52, wherein the request message comprises configuration information about related to an physical channel of the UE.

54. The apparatus of claim 53, wherein the configuration information comprises at least one of: a cell-specific scrambling code, a time slot for transmitting from the UE, or a channelization code.

55. The apparatus of claim 52, wherein the request message is received before a handover of the UE from the other apparatus to the apparatus.

56. The apparatus of claim 52, wherein the response message is transmitted before a handover of the UE from the other apparatus to the apparatus.
